(19) United States
(12) Patent Application Publication
(10) Pub. No.: US 2018/0129059 A1
(43) Pub. Date: May 10, 2018

(54) LIGHTING APPARATUS WITH CORRESPONDING DIFFRACTIVE OPTICAL ELEMENT

(71) Applicant: EVERREADY PRECISION IND. CORP., Kaohsiung City (TW)

(72) Inventors: JYH-LONG CHERN, Zhubei City (TW); CHIH-MING YEN, Taipei City (TW)

(21) Appl. No.: 15/867,241

(22) Filed: Jan. 10, 2018

Related U.S. Application Data
(62) Division of application No. 14/884,094, filed on Oct. 15, 2015.

(30) Foreign Application Priority Data
Aug. 28, 2015 (TW) 104128453

(51) Int. Cl. G02B 27/09; G02B 5/18; H01S 3/00

(52) U.S. Cl. CPC G02B 27/0944; H01S 3/005; G02B 5/1819; G02B 27/0927

(57) ABSTRACT

A lighting apparatus includes a laser source module and a diffractive optical module. The laser source module emits a laser beam. When the laser beam is operated in a transverse mode or a multi-transverse mode, the laser beam has a first laser beam pattern. The diffractive optical module is arranged in front of the laser source module or at a location that receives the laser beam, so that the laser beam is irradiated on the diffractive optical module. The diffractive optical module includes a first structure pattern corresponding to the first laser beam pattern. After the laser beam is diffracted by the first structure pattern, a first structured light with a first structured light pattern is generated.

### CROSS REFERENCE TO RELATED APPLICATION

This application is a divisional of U.S. patent application Ser. No. 14/884,094, filed on Oct. 15, 2015, and entitled “LIGHTING APPARATUS WITH CORRESPONDING DIFFRACTIVE OPTICAL ELEMENT”, which claims the benefit of and priority to Taiwan Patent Application No. 104128452, now Taiwan Patent No. 1585467, all of which are herein incorporated by references.

### FIELD OF THE INVENTION

The present invention relates to a lighting apparatus with a corresponding diffractive optical element according to the laser beam pattern of the used laser source, and more particularly to a lighting apparatus with a laser source that is operated in a transverse mode or a multi-transverse mode.

### BACKGROUND OF THE INVENTION

The term “laser” is originated as an acronym for “light amplification by stimulated emission of radiation”. The laser beam is a light beam that is emitted through a process of optical amplification based on the stimulated emission of electromagnetic radiation. The laser beam has special properties such as low divergence, coherence, monochromaticity and high luminance (intensity). Consequently, laser beams are usually applied to many sections such as precision industries, medical treatment sections, materials processing industries, communication technologies, remote control technologies, telemetric technologies, holographic photography sections, defense industries or any other associated optical and electronic industries. Generally, a laser device is composed of three main components, including an active medium (also referred as a pumping source), a gain medium and an optical resonator. Depending on the laser medium, the laser devices are divided into three types, i.e., a liquid laser device, a gas laser device and a solid laser device. The gas laser device such as a He—Ne laser is widely used. In addition, the widely-used solid laser device includes a semiconductor laser device or a laser diode (LD).

Ideally, the amplitude distribution (or an intensity profile) of a laser beam is in a Gaussian distribution profile. FIG. 1 schematically illustrates an intensity distribution of a laser beam in a Gaussian distribution profile and the corresponding laser beam pattern (denoted as 00). In reality, because of the non-uniform material of the inner structure of the laser device or the influence of the tiny dust, a portion of the laser beam intensity is in the Gaussian distribution and another portion of the laser beam intensity is related to spatial noise in contrast. The noise is the A.C. signal with disordered spatial frequency or with higher frequency. After the noise is filtered by a low pass filer, the ideal Gaussian distribution profile without noise can be obtained. This ideal Gaussian distribution profile is a D.C. signal contains no any other signal (i.e., the spatial frequency ω is 0), and also referred as a zero order or a D.C. term. Moreover, depending on the shape of the optical resonator, the laser beam pattern is similar to a circular beam with concentrated intensity in the center. Under this circumstance, the laser is said to be operated in a “00” mode as derived from the mathematical solutions of some differential equations based on a resonator consideration.

Generally, for utilizing the laser beam, a diffractive optical element (DOE) is arranged within the laser device (laser cavity or resonator) or disposed outside the laser device to adjust and change the pattern of the laser beam. Consequently, a structured light with a specified pattern (e.g., a dot pattern, a line pattern, a stripe pattern or an array pattern) is produced.

FIG. 2A is a schematic side view illustrating the operations of a laser device with a diffractive optical element according to the conventional technology. As shown in FIG. 2A, the laser device 100 comprises the diffractive optical element (DOE) 11. The diffractive optical element 11 is disposed on a first surface 121 of a substrate 12, and arranged in front of a laser source 10. The substrate 12 is made of a transparent material. The laser source 10 emits a laser beam 10a. The laser beam 10a is modulated by a collimating lens 14. Consequently, a parallel collimated beam 10b is outputted from the collimating lens 14. Moreover, specified microstructures (not shown) are formed on the diffractive optical element 11. When the collimated beam 10b passes through the diffractive optical element 11, the collimated beam 10b is diffracted by the microstructures. Consequently, a structured light 13 with a desired structured light pattern is projected to a specified distance or a specified space. In some cases, the collimating lens 14 may be removed, and the laser light is directly guided to DOE 11 to produce the structured lighting pattern while the contrast of structured light may be poor.

In case that the diffractive optical element for a laser diode is employed, the diffractive optical element has to effectively cover the distribution range of the laser beam or the collimated beam on a plane that is perpendicular to a propagation direction. In such way, the beam diffraction can be effectively generated.

FIG. 2B schematically illustrates two possible microstructures formed on the diffractive optical element of FIG. 2A. As shown in FIG. 2B, the two kinds of possible microstructures 110 on the diffractive optical element 11 are circular and rectangular. The shape of the microstructure 110 is dependent on the laser beam profile, e.g. a circular Gaussian beam or an elliptic Gaussian one. Moreover, the microstructure 110 may be designed to have any other shape according to the practical requirements.

FIGS. 2C and 2D are schematic side views illustrating the operations of two laser devices that are modified according to the concepts of the laser device of FIG. 2A. In the laser device 101 of FIG. 2C, the diffractive optical element 11 is disposed on a second surface 122 of the substrate 12. In the laser device 102 of FIG. 2D, the laser source 10 does not cooperate with the collimating lens. That is, the laser beam 10a from the laser source 10 is a dot beam. The arrangement of FIG. 2C can produce the structured light 13 that has the same structured light pattern as FIG. 2A. The arrangement of FIG. 2D can produce the structured light 132 that has the similar structured light pattern to FIG. 2A. Moreover, the arrangements of FIGS. 2A, 2C and 2D may be combined with each other to produce the similar or close result. For example, two diffractive optical elements are respectively formed on two opposite surfaces of the substrate 12, or a dot laser source cooperates with a diffractive optical element on a second surface of the substrate 12, or a dot laser source cooperates with two diffractive optical elements on two opposite surfaces of the substrate 12.

As mentioned above, if the diffractive optical element cannot effectively cover the distribution range of the laser beam or the collimated beam, the structured light pattern corresponding to the laser beam in the Gaussian distribution and from the laser source will contain a portion of D.C. term (i.e., a circular dot beam), i.e., additionally original laser spot will be added to structured light pattern. On a first rough look, it is generally to be claimed that the zero-order diffraction were too large. Actually, it is really not related to diffraction, it is simply that originally incident laser beam profile is not fully matched the area of DOE and too large in most cases. Under this circumstance, the structured light pattern cannot be used in the specified application. Moreover, in case that the used laser source (e.g., a laser diode) with coherence or partial coherence is operated in higher power, the gain efficacy in the optical resonator is continuously increased. Under this circumstance, the laser beam pattern is no longer the circular dot beam (i.e., in the Gaussian distribution). In comparison with the fundamental mode of the Gaussian distribution, the laser beam pattern is in a transverse mode or a multi-transverse mode. For example, various laser beam patterns in the transverse mode or the multi-transverse mode are shown in FIGS. 3A and 3B.

The laser beam patterns in the transverse mode or the multi-transverse mode are electromagnetic fields of laser beams that are measured on a plane perpendicular to the propagation direction. Depending on the shapes of the optical resonator, the laser beam patterns are distinguished. In case that the optical resonator has a cylindrical shape, various laser beam patterns in the transverse mode or the multi-transverse mode are shown in FIG. 3A. In case that the optical resonator has a rectangular shape, various laser beam patterns in the transverse mode or the multi-transverse mode are shown in FIG. 3B.

In FIG. 3A, the numeral 01* (or a circular mode 01*) indicates a ring-shaped pattern (or a donut pattern). That is, the center of the laser beam pattern is a hole without light pattern distribution. FIG. 4 schematically illustrates an amplitude distribution (or an intensity profile) of a laser beam corresponding to the ring-shaped laser beam pattern (or the circular mode 01*). From FIG. 3 and FIG. 4, it is found that the center hole of the ring-shaped pattern corresponds to a relative minimum intensity and the ring-shape pattern itself corresponds to a relative maximum intensity.

In many laser applications, the required laser beam from the laser source is in the amplitude (intensity) distribution. That is, the laser beam with smaller divergence and diameter (e.g., the circular beam in the “00” mode as shown in FIG. 1 or the fundamental mode) is required. Since the intensity of the circular beam is concentrated in the center, the structured light pattern resulted from the cooperation of this laser beam and the diffractive optical element is still unsatisfied. That is, it is important to use the laser beam with the lower D.C. term. In case that the laser beam pattern from the laser source is in the transverse mode or the multi-transverse mode, the laser beam with the lower D.C. term (i.e., the laser beam whose intensity is not concentrated in the center) is possibly used. However, in case that this laser source cooperates with the conventional diffractive optical element, the microstructure on the diffractive optical element cannot effectively control the beam diffraction. Under this circumstance, the desired structured light pattern cannot be acquired.

Therefore, it is important to overcome the drawbacks of the conventional technologies.

### SUMMARY OF THE INVENTION

An object of the present invention provides a lighting apparatus with a corresponding diffractive optical element. The corresponding diffractive optical element is selected according to the laser beam pattern of the used laser source. Especially, the laser source operated in a transverse mode or a multi-transverse mode can be effectively utilized. In addition, the laser source in the transverse mode or the multi-transverse mode can well cooperate with the diffractive optical element.

In accordance with an aspect of the present invention, there is provided a lighting apparatus. The lighting apparatus includes a laser source module and a diffractive optical module. The laser source module emits a laser beam. When the laser beam is operated in a transverse mode or a multi-transverse mode, the laser beam has a first laser beam pattern. The diffractive optical module is arranged in front of the laser source module or at a location that receives the laser beam, so that the laser beam is irradiated on the diffractive optical module. The diffractive optical module includes a first structure pattern corresponding to the first laser beam pattern. After the laser beam is diffracted by the first structure pattern, a first structured light with a first structured light pattern is generated

In accordance with another aspect of the present invention, there is provided a lighting apparatus. The lighting apparatus includes a laser source module, a collimating optical element and a diffractive optical module. The laser source module emits a laser beam. When the laser beam is operated in a transverse mode or a multi-transverse mode, the laser beam has a first laser beam pattern. The collimating optical element is arranged in front of the laser source module. After the laser beam is modulated by the collimating optical element, a collimated beam is generated. The diffractive optical module is arranged in front of the collimating optical element and receives the collimated beam. The diffractive optical module includes a first structure pattern corresponding to the first laser beam pattern. After the collimated beam is diffracted by the first structure pattern, a first structured light with a first structured light pattern is generated.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates an amplitude distribution of a laser beam in a Gaussian distribution profile and the corresponding laser beam pattern;

FIG. 2A is a schematic side view illustrating the operations of a laser device with a diffractive optical element according to the conventional technology;

FIG. 2B schematically illustrates two possible microstructures formed on the diffractive optical element of FIG. 2A;

FIGS. 2C and 2D are schematic side views illustrating the operations of two laser devices that are modified according to the concepts of the laser device of FIG. 2A;

FIGS. 3A and 3B schematically illustrate various laser beam patterns in a transverse mode or a multi-transverse mode;

FIG. 4 schematically illustrates an amplitude distribution of a laser beam corresponding to the ring-shaped laser beam pattern (or the circular mode 01*);

FIG. 5 is a schematic functional block diagram illustrating a lighting apparatus according to an embodiment of the present invention;

FIG. 6A is a schematic side view illustrating the operations of a lighting apparatus according to a first embodiment of the present invention;

FIG. 6B schematically illustrates a first diffractive optical element and a first structure pattern of the diffractive optical module of the lighting apparatus;

FIG. 7 is a schematic side view illustrating the operations of a lighting apparatus according to a second embodiment of the present invention;

FIG. 8A is a schematic side view illustrating the operations of a lighting apparatus according to a third embodiment of the present invention;

FIG. 8B schematically illustrates a first diffractive optical element and a third structure pattern of the diffractive optical module of the lighting apparatus; and

FIG. 9 is a schematic side view illustrating the operations of a lighting apparatus according to a fourth embodiment of the present invention.

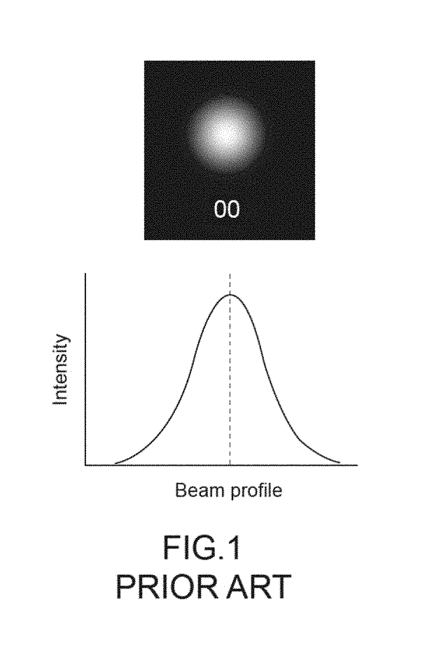

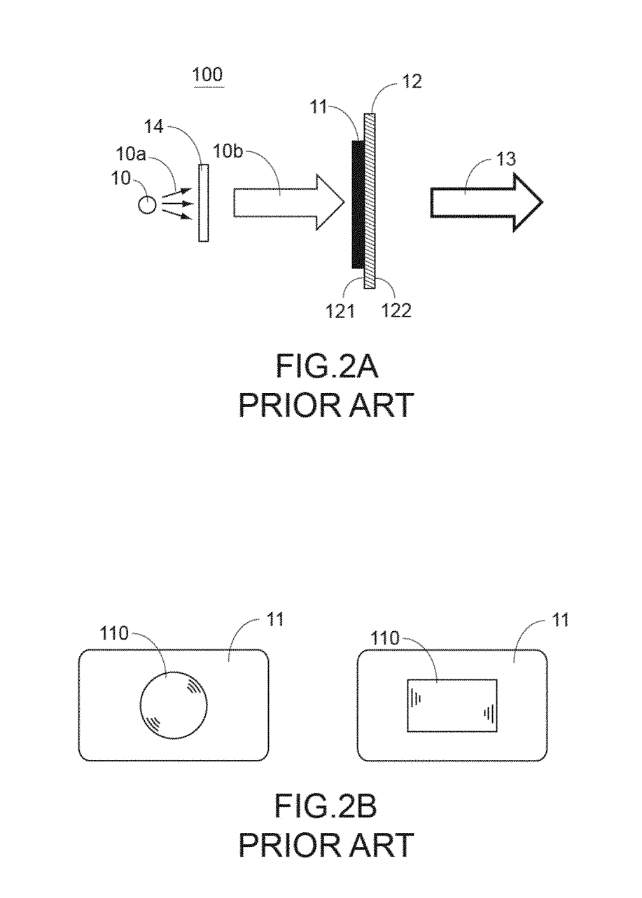

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown in order to clearly describe the technical features of the present invention. In the following embodiments, components that are relevant to each other or have similar function are designated by similar numeral references.

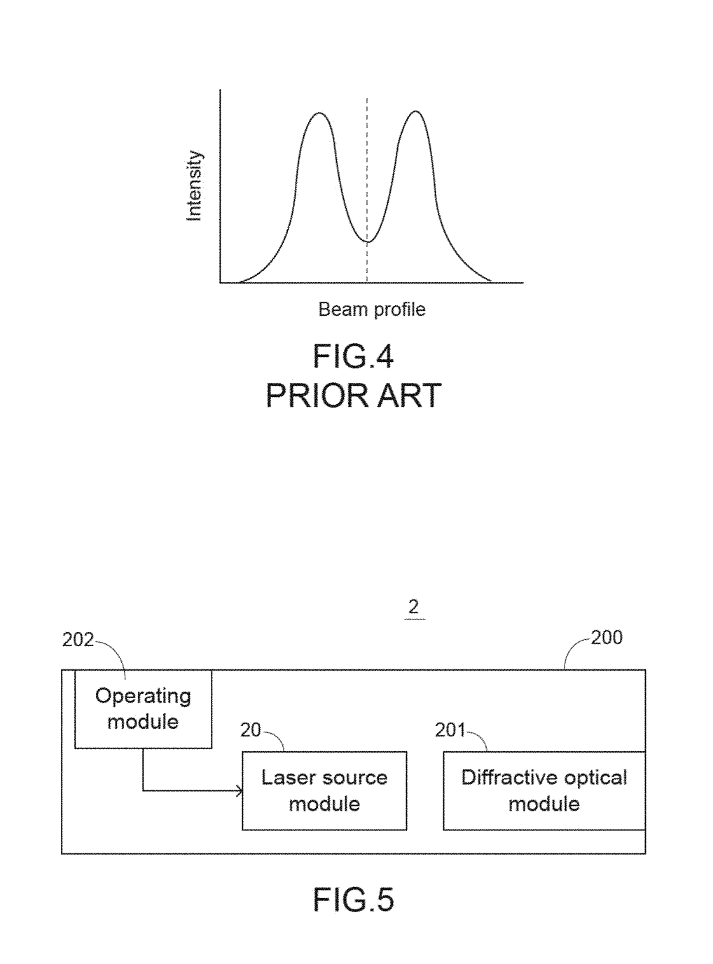

FIG. 5 is a schematic functional block diagram illustrating a lighting apparatus according to an embodiment of the present invention. As shown in FIG. 5, the lighting apparatus 2 comprises a casing 200, a laser source module 20, a diffractive optical module 201 and an operating module 202. The laser source module 20 and the diffractive optical module 201 are accommodated within the casing 200. The operating module 202 is disposed on the casing 200. Through the operating module 202, the user can turn on the laser source module 20, turn off the laser source module 20 or adjust an operation mode of the laser source module 20. Optionally, the outer surface of the lighting apparatus 2 is equipped with an elongated structure, a pillar structure or any other appropriate structure for allowing the user to hold it, or sheathing it around the finger, or facilitating the effective integration of the overall mechanism. Preferably, the overall effective height (or the total thickness) of the casing 200 or the lighting apparatus 2 is equal to or smaller than 10 mm. Although the dimension of lighting apparatus is small here, by precision fabrication technology, the casing 200 is still capable to have additional (mechanical, electric, magnetic, optical or the mixed) structures such that to the feedback light, stray light or unwanted light can be blocked out or be eliminated effectively and the unwanted light will not incident to DOE 201 or back to affect the laser source 20. Meanwhile, it is also possible by using additional structure within casing 200 to pick up a small amount of the light from the laser 20 or the structured light form DOE 201 and pass to operating module 201 as for feedback control. Consequently, the lighting apparatus 2 can be effectively integrated into a handheld device. In accordance with a fabricating method, the laser source module 20 and the diffractive optical module 201 are fixed within the casing 200. Moreover, an end of the casing 200 is transparent or hollow, so that the generated light beam can be projected out. The operating module 202 is electrically connected with the laser source module 20. Moreover, the operating module 202 can transmit a control signal.

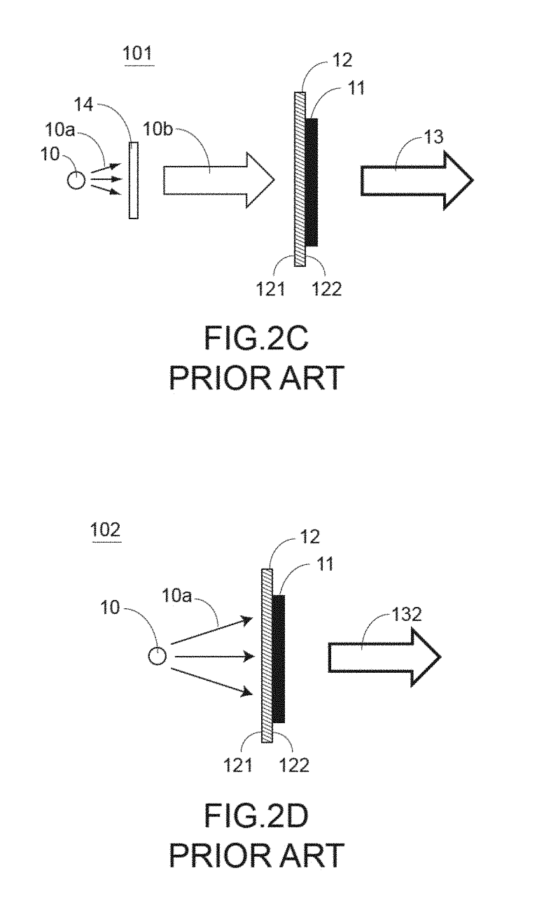

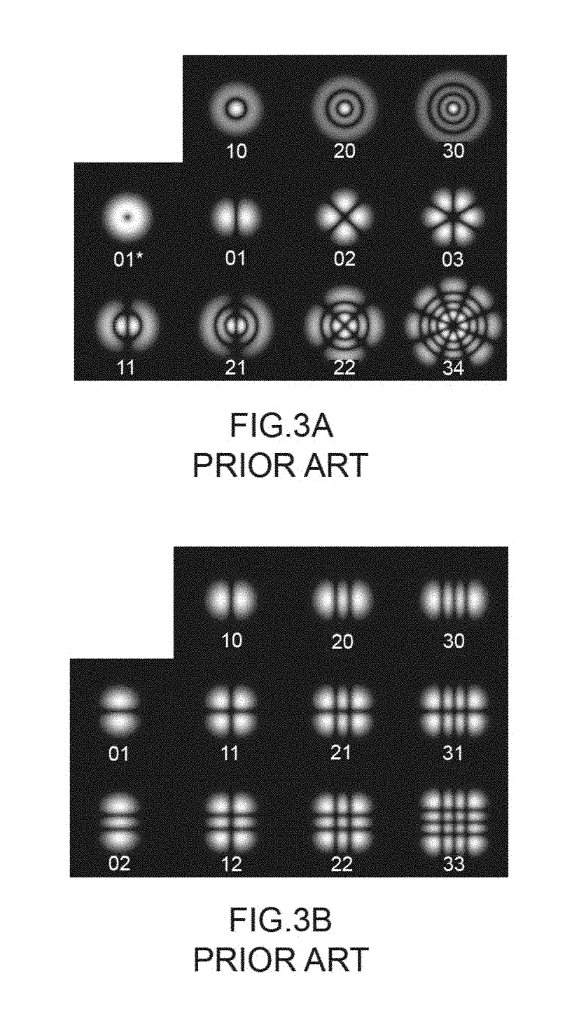

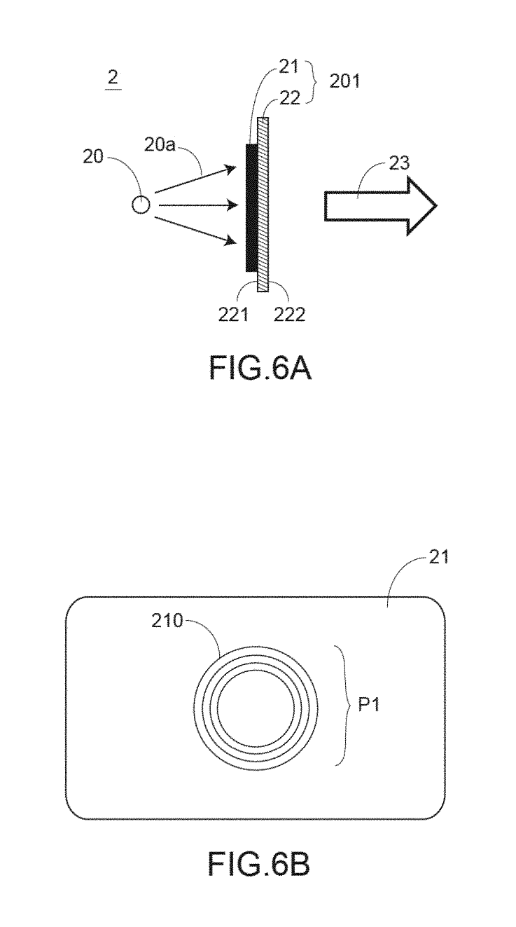

Hereinafter, the operations of the lighting apparatus according to a first embodiment of the present invention will be described. FIG. 6A is a schematic side view illustrating the operations of a lighting apparatus according to a first embodiment of the present invention. In this embodiment, the laser source module 20 emits a laser beam 20a, and the laser beam 20a is a dot beam. That is, the laser source 20a does not cooperate with a collimating lens. In accordance with a feature of the present invention, the laser source module 20 is operated in higher power. Consequently, the generated laser beam 20a is operated in a transverse mode or a multi-transverse mode. That is, the laser beam pattern of the laser beam 20a is in a non-fundamental mode (i.e., in a non-Gaussian distribution). For example, various laser beam patterns in the transverse mode or the multi-transverse mode are shown in FIGS. 3A and 3B.

In this embodiment, a first laser beam pattern of the laser beam 20a is the numeral 01* pattern of FIG. 3A (or a circular mode 01* pattern). That is, the first laser beam pattern is a ring-shaped pattern (or a donut pattern), or the center of the first laser beam pattern is a hole without light pattern distribution. Moreover, the laser source module 20 comprises at least one laser source. An example of the laser source includes but is not limited to a semiconductor laser source or a laser diode. Moreover, the laser source has coherence or partial coherence. In some other embodiments, the laser source module 20 further comprises a non-linear optical crystal or a liquid (or other substance) to produce other light beams with different wavelengths or in different spectra.

The diffractive optical module 201 is arranged in front of the laser source module 20 or at a location that receives the laser beam 20a, so that the diffractive optical module 201 is irradiated by the laser beam 20a. Moreover, the diffractive optical module 201 comprises a first structure pattern P1 (see FIG. 6B). In this embodiment, the diffractive optical module 201 comprises a substrate 22 and a first diffractive optical element 21. The substrate 22 has a first surface 221 and a second surface 222. The first diffractive optical element 21 is disposed on the first surface 221 of the substrate 22 that is located near the laser source module 20. The substrate 22 is made of a transparent material. Consequently, the associated light beam can pass through the substrate 22. Moreover, the first structure pattern P1 is formed on the first diffractive optical element 21.

FIG. 6B schematically illustrates the first diffractive optical element 21 and the first structure pattern P1. In accordance with another feature of the present invention, the first structure pattern P1 on the first diffractive optical element 21 corresponds to the first laser beam pattern. Consequently, when the laser beam passes through the first structure pattern P1, the laser beam can be effectively diffracted. In particular, during the process of installing the laser source module 20 and the diffractive optical module 201 of the lighting apparatus 2, it is necessary to test the laser beam 20a from the laser source module 20 in order to realize the type of the laser beam pattern. That is, it is necessary to recognize the type of the laser beam pattern corresponding to one of the laser beam patterns in the transverse mode or the multi-transverse mode. Then, the first structure pattern P1 on the first diffractive optical element 21 is determined according to the recognized type of the laser beam pattern.

As shown in FIG. 6B, plural first microstructures 210 are formed on the first diffractive optical element 21. In this embodiment, the first laser beam pattern is set as the circular mode 01* pattern. Consequently, the plural first microstructures 210 are distributed according to the distribution of the circular mode 01* pattern (i.e., the light pattern distribution or the intensity distribution). In other words, the plural first microstructures 210 are formed on the first diffractive optical element 21 in a ring-shaped arrangement. In this embodiment, the first structure pattern P1 is constituted by all of the plural first microstructures 210.

Especially, the location of the first laser beam pattern on the first diffractive optical element 21 corresponds to the location of the first structure pattern P1, and the area of the first laser beam pattern on the first diffractive optical element 21 is smaller than or equal to the area of the first structure pattern P1. Consequently, when the laser beam 20a is irradiated on the first diffractive optical element 21, the laser beam 20a can be effectively diffracted. That is, the distribution of the first structure pattern P1 has to cover the distribution range of the first laser beam pattern. Consequently, any part of the first laser beam pattern is not beyond or outside the first structure pattern P1.

By means of the above architecture, the laser beam 20a can be effectively diffracted. Consequently, a first structured light 23 with a first structured light pattern is generated (see FIG. 6A).

In the above embodiment, the plural first microstructures 210 are symmetrically distributed. The reason is that the generated laser beam pattern is also symmetrically distributed. That is, the upper part and the lower part, the left part and the right part and the oblique parts are symmetric to each other with respect to the center of the laser beam pattern. However, in some situations, the generated laser beam pattern is not in the ideal symmetry as the laser beam patterns of FIG. 3A or FIG. 3B because the material of inner structure of the lighting apparatus is not uniform or tiny dust exists or the laser source is operated at higher power. Under this circumstance, the generated laser beam pattern is asymmetrically distributed, or the generated laser beam pattern is a combination of several laser beam patterns in different modes. Consequently, in case that the first laser beam pattern is asymmetric, the corresponding microstructures are asymmetrically distributed.

It is noted that numerous modifications and alterations may be made while retaining the teachings of first embodiment. For example, in another embodiment, the first diffractive optical element 21 is disposed on the second surface 222 of the substrate 22. Since the substrate 22 is transparent, the diffracted result or the structured light pattern is not obviously distinguished from the first embodiment. Moreover, since the area of the first laser beam pattern on the first diffractive optical element 21 is smaller than the area of the first structure pattern P1, the range of the plural first microstructures can be larger than that of FIG. 6B or the number of the plural first microstructures can be more than that of FIG. 6B. That is, the portion of the first diffractive optical element 21 where the laser beam pattern is irradiated should contain microstructures, and portions of the microstructures are possibly not irradiated by the laser beam pattern. Under this circumstance, the first structure pattern is constituted by portions of the plural first microstructures.

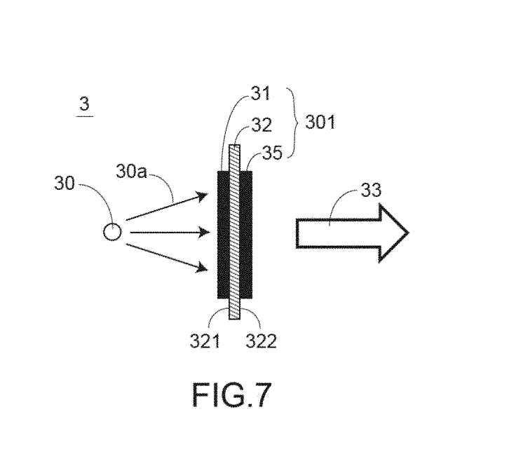

Hereinafter, a lighting apparatus according to a second embodiment will be described. FIG. 7 is a schematic side view illustrating the operations of a lighting apparatus according to a second embodiment of the present invention. In comparison with the first embodiment, the diffractive optical module 301 of the lighting apparatus 3 further comprises a second diffractive optical element 35. The second diffractive optical element 35 is disposed on the second surface 322 of the substrate 32. Similarly, plural second microstructures (not shown) are formed on the second diffractive optical element 35. A second structure pattern (not shown) is constituted by the plural second microstructures. The second structure pattern is correlated with the first structured light pattern that is generated by the first diffractive optical element 31.

As mentioned in the first embodiment, the first structured light pattern 23 is generated after the laser beam 20a passes through the first diffractive optical element 21. In case that the first structured light pattern 23 passes through another diffractive optical element (e.g., the second diffractive optical element 35 of FIG. 7), another diffraction process occurs. Especially, the location of the first laser beam pattern on the second diffractive optical element 35 corresponds to the location of the second structure pattern, and the area of the first laser beam pattern on the second diffractive optical element 35 is smaller than or equal to the area of the second structure pattern.

The purpose of the above architecture is used to generate a specified structured light pattern and re-modulate the light beam shape of the corresponding light beam. Consequently, in the second embodiment, the second structure pattern of the second diffractive optical element 35 may be identical to the first structure pattern of the first diffractive optical element 31 or different from the first structure pattern of the first diffractive optical element 31 according to the required structured light pattern.

By means of the above architecture, the first structured light (e.g., the first structured light of FIG. 6A) can be effectively diffracted. Consequently, a second structured light 33 with a second structured light pattern is generated (see FIG. 7).

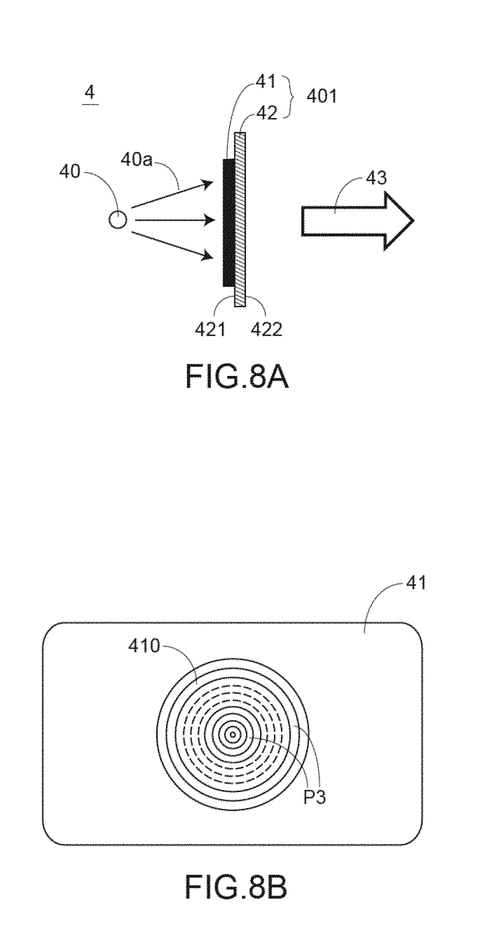

Hereinafter, a lighting apparatus according to a third embodiment will be described. FIG. 8A is a schematic side view illustrating the operations of a lighting apparatus according to a third embodiment of the present invention. FIG. 8B schematically illustrates the first diffractive optical element 41 and a third structure pattern P3. In comparison with the first embodiment, the first diffractive optical element 41 of the third embodiment is distinguished.

As mentioned above, the user can adjust the operation mode of the laser source module through the operating module. Consequently, the generated laser beam is adjusted, and the laser beam pattern is correspondingly changed. That is, for generating another laser beam pattern, the user may adjust the operation mode of at least one laser source (e.g., adjust the output power or modulate the length or other scale feature of the optical resonator) in order to change the projected laser beam pattern in the transverse mode or the multi-transverse mode. In some other embodiments, the laser source module further comprises an optical lens group (not shown). By adjusting the relative distance between the optical lens group and the diffractive optical module, the projected laser beam pattern is correspondingly adjusted.

In the third embodiment, a second laser beam pattern of the laser beam 40a from the laser source module 40 is the numeral 10 pattern of FIG. 3A (also referred as a circular mode 10 pattern). That is, the second laser beam pattern is a ring-shaped pattern with a light pattern distribution in the center. Similarly, the third structure pattern P3 on the first diffractive optical element 41 corresponds to the second laser beam pattern.

As shown in FIG. 8B, the third structure pattern P3 is constituted by portions of plural first microstructures 410. In particular, as shown in FIG. 8B, the third structure pattern P3 contains the microstructures 410 in the middle region and the microstructures 410 in the non-dotted region (i.e., the region indicated by solid lines). That is, the plural first microstructures 410 are distributed according to the distribution of the circular mode 10 pattern (i.e., the light pattern distribution or the intensity distribution) and further according to distribution of other mode pattern (e.g., the circular mode 01* pattern).

An example of adjusting the laser mode will be illustrated as follows. For example, the first laser beam pattern (i.e., the circular mode 01* pattern) corresponding to the laser beam is changed to the second laser beam pattern (i.e., the circular mode 10 pattern). In case that the laser beam pattern is changed, the irradiated range or location of the diffractive optical element 41 is correspondingly changed. For example, as shown in FIG. 8B, the irradiated range or location is changed from the microstructures 410 of the dotted region to the microstructures 410 of the solid region.

In other words, a portion of the first microstructures 410 constitute the first structure pattern P1 of FIG. 6B, and another portion of the first microstructures 410 constitute the third structure pattern P3. Depending to the distribution of the laser beam pattern, the portion of the first microstructures 410 constituting the first structure pattern P1 and the portion of the first microstructures 410 constituting the third structure pattern P3 may be partially overlapped with each other. Consequently, in the third embodiment, the lighting apparatus 4 can effectively utilize laser beam patterns in various modes.

Similarly, the location of the second laser beam pattern on the first diffractive optical element 41 corresponds to the location of the third structure pattern P3, and the area of the second laser beam pattern on the first diffractive optical element 41 is smaller than or equal to the area of the third structure pattern P3. Consequently, when the laser beam 40a is irradiated on the first diffractive optical element 41, the laser beam 40a can be effectively diffracted. That is, the distribution of the third structure pattern P3 has to cover the distribution range of the second laser beam pattern. Consequently, any part of the second laser beam pattern is not beyond or outside the third structure pattern P3.

By means of the above architecture, the laser beam 40a can be effectively diffracted. Consequently, a third structured light 43 with a third structured light pattern is generated (see FIG. 8A).

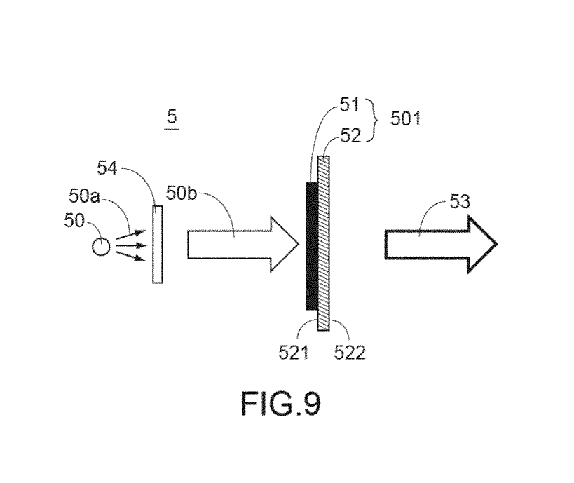

Hereinafter, a lighting apparatus according to a fourth embodiment will be described. FIG. 9 is a schematic side view illustrating the operations of a lighting apparatus according to a fourth embodiment of the present invention. In comparison with the first embodiment, the lighting apparatus 5 of this embodiment further comprises a collimating optical element 54. The collimating optical element 54 is arranged in front of the laser source module 50. The collimating optical element 54 is used for adjusting the laser beam 50a and generating a collimated beam 50b. Although the laser beam 50a is collimated into the collimated beam 50b, the collimated beam 50b also contains the laser beam pattern of the laser beam 50a (e.g., the first laser beam pattern corresponding to the circular mode 01* pattern).

In this embodiment, the collimated beam 50b is diffracted by the first diffractive optical element 51 of the diffractive optical module 501. The designs of forming the first structure pattern or the plural first microstructures on the first diffractive optical element 51 are similar to those of the first embodiment. In particular, due to the collimating adjustment of the collimating optical element 54, the collimated beam 50b has smaller divergence than the laser beam 50a or is closer to the parallel beam. Consequently, when the collimated beam 50b is irradiated on the first diffractive optical element 51, the distribution range is smaller than that of the first embodiment.

By means of the above architecture, the collimated beam 50b can be effectively diffracted. Consequently, as shown in FIG. 9, a first structured light 53 having a similar or identical result to the first embodiment is generated.

Similarly, the collimating optical element 54 can be applied to the lighting apparatus of the second embodiment or the third embodiment, or applied to the variant examples of the first embodiment, the second embodiment or the third embodiment. Under this circumstance, the generated laser beam pattern also has the similar or identical result.

From the above descriptions, the present invention provides a lighting apparatus with a corresponding diffractive optical element. The corresponding diffractive optical element is selected according to the laser beam pattern of the used laser source. By means of the architecture, the laser source (especially the laser source operated in a transverse mode or a multi-transverse mode) can be effectively utilized. Consequently, the desired structured light pattern can be generated by the diffraction technology. In addition, the laser source in the transverse mode or the multi-transverse mode can well cooperate with the diffractive optical element.

Consequently, the lighting apparatus of the present invention is capable of achieving the purposes of the present invention while eliminating the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A lighting apparatus, comprising:
a laser source module emitting a laser beam, wherein the laser beam is operated in a transverse mode or a multi-transverse mode, and the laser beam operated in the transverse mode or the multi-transverse mode has a first laser beam pattern; and
a diffractive optical module arranged in front of the laser source module or at a location to receive irradiation of the first laser beam pattern of the laser beam, wherein the diffractive optical module comprises:
a substrate made of a transparent material and having a first surface and a second surface;
a first diffractive optical element disposed on the first surface of the substrate and comprising plural first microstructures configured to provide a first structure pattern, wherein the first microstructures are symmetrically distributed or asymmetrically distributed with respect to the first structure pattern, and the first structure pattern is configured to diffract the laser beam to generate a first structured light with a first structured light pattern; and
a second diffractive optical element disposed on the second surface of the substrate and comprising plural second microstructures, wherein a second structure pattern is constituted by the plural second microstructures, and wherein after the first structured light is diffracted by the second structure pattern, a second structured light with a second structured light pattern is generated, and the second structure pattern is different from the first structure pattern;
wherein a shape of the first structure pattern is mapped to match a shape of the first laser beam pattern.

2. The lighting apparatus according to claim 1, wherein a location of the first laser beam pattern on the second diffractive optical element corresponds to a location of the second structure pattern, wherein an area of the first laser beam pattern on the second diffractive optical element is smaller than or equal to an area of the second structure pattern.

3. The lighting apparatus according to claim 1, wherein the first laser beam pattern of the laser beam is further adjusted to a second laser beam pattern, and wherein a third structure pattern is constituted by a portion of the plural first microstructures, and the third structure pattern corresponds to the second laser beam pattern, wherein after the laser beam is diffracted by the third structure pattern, a third structured light with a third structured light pattern is generated.

4. The lighting apparatus according to claim 3, a location of the second laser beam pattern on the first diffractive optical element corresponds to a location of the third structure pattern, wherein an area of the second laser beam pattern on the first diffractive optical element is smaller than or equal to an area of the third structure pattern.

5. A lighting apparatus, comprising:
a laser source module emitting a laser beam, wherein when the laser beam is operated in a transverse mode or a multi-transverse mode, the laser beam has a first laser beam pattern;
a collimating optical element arranged in front of the laser source module, wherein after the laser beam is modulated by the collimating optical element, a collimated beam is generated; and
a diffractive optical module arranged in front of the collimating optical element and receiving the collimated beam, wherein the diffractive optical module comprises a first structure pattern corresponding to the first laser beam pattern, wherein after the collimated beam is diffracted by the first structure pattern, a first structured light with a first structured light pattern is generated.
